(19) United States
(12) Patent Application Publication
(10) Pub. No.: US 2016/0007629 A1
(43) Pub. Date: Jan. 14, 2016

(54) HIGH-PROTEIN CRISPS UTILIZING A SINGLE PROTEIN ISOLATE

(71) Applicant: KERRY GROUP SERVICES INTERNATIONAL, LTD., Tralee (IE)

(72) Inventors: Klinton E. Egelhoff, Loves Park, IL (US); Shashi Ramaiah, Rockton, IL (US); James C. Cross, Kansas City, MO (US); Homer N. Showman, JR., Shellsburgh, IA (US)

(21) Appl. No.: 14/772,685

(22) PCT Filed: Mar. 6, 2014
(86) PCT No.: PCT/US2014/021344

§ 371 Date: Sep. 3, 2015

Related U.S. Application Data
(60) Provisional application No. 61/773,611, filed on Mar. 6, 2013.

(51) Int. Cl. A23J 3/16; A23L 1/305

(52) U.S. Cl. CPC A23J 3/16; A23L 1/3055; A23V 2002/00

(57) ABSTRACT

High-protein crisp products and methods of making these products are provided. The products are made from a mixture of ingredients, including a hydrolyzed soy protein isolate and a source of a Group I or Group II metal (e.g., CaCO₃). The mixture preferably further comprises a filler (e.g., a starch) and water. The blended dry ingredients are preferably first introduced into a preconditioner, after which they are passed through an extruder barrel to yield an extrudate that expands upon exiting the extruder outlet to form the crisp rice-like product.

### RELATED APPLICATION

The present application claims the priority benefit of U.S. Provisional Patent Application Ser. No. 61/773,611, filed Mar. 6, 2013, entitled SINGLE ISOLATE PRODUCT, incorporated by reference in its entirety herein.

### BACKGROUND OF THE INVENTION

1. Field of the Invention

The present invention is broadly concerned with high-protein crisp products and methods of forming those products via extrusion processes.

2. Description of the Prior Art

There are numerous ways of adding a protein source to a food product. Unfortunately, the addition of a high percentage of protein often results in flavors and textures that are not palatable. One of the solutions to this flavor dilemma is to incorporate high-protein, crisp rice-like pieces into the food to increase the protein level of the food. This type of high-protein crisp rice-like piece can be manufactured using twin screw extrusion technology. Formulations using protein isolates and protein concentrates allow for the manufacture oftexturally-acceptable, crisp rice-like products. Pieces with high-protein levels have been achieved using current extrusion technology coupled with these high-protein ingredients. Once produced, these crisp rice-like pieces can be used to increase the protein levels of confectionary products, cereals, snacks, and nutritional bars. These pieces can also be incorporated into dairy products, such as yogurt or ice cream treats, to add texture and increase the protein level of the food.

However, making these high-protein crisp rice-like pieces has presented a number of issues over the years. A blend of both a hydrolyzed and a non-hydrolyzed soy protein isolate was commonly used to formulate these pieces. Products with 70-75% by weight protein content were being produced using this blended soy protein isolate. Unfortunately the process of blending the non-hydrolyzed and hydrolyzed isolates was inconsistent because the commercially available products vary significantly in the quality of the blend. This inconsistency causes issues that lead to production down-time and wasted food. Consequently, some formulators began to make their own blends of hydrolyzed and non-hydrolyzed isolates. This on-site blending of the isolates rather than buying a single blended isolate allowed the blend % to be changed very rapidly if there are differences in the degree of hydrolysis in the isolates that would affect the manufacture of the crisp rice-like pieces. More often than not the degree of hydrolysis of the hydrolyzed isolates varies shipment-to-shipment. Some success has been achieved using this approach, but the variation in the isolates still creates production issues. If the degree of hydrolysis changes during production due to changes in the hydrolyzed portion of the blend, the protein fibers in the product line up, or stratify, and form a puffy, less crunchy product that is very similar to texturized vegetable protein or “TVP.” When the texture of the pieces are observed becoming more like TVP, the isolate blend must be adjusted.

There is a need for a product that does not require a split of hydrolyzed and non-hydrolyzed isolates, but rather just one form of an isolate. The product should duplicate the texture and flavor of the same products made with the formulas that use a combination of hydrolyzed and non-hydrolyzed isolates. A single isolate solution would simplify the formula, as well as eliminate the need for scheduling, purchasing, and storing of another ingredient.

### SUMMARY OF THE INVENTION

The present invention provides a method of forming a high-protein crisp product. The method comprises providing a mixture of ingredients, wherein the ingredients comprise a hydrolyzed protein and a source of a Group I or II metal. The protein is present in the mixture at a level of at least about 75% by weight, based upon the total weight of the ingredients taken as 100% by weight. The mixture is passed through an extruder so as to form the high-protein crisp product.

The invention is also concerned with a high-protein, expanded, crisp rice-like extrudate. In one embodiment, the extrudate comprises a hydrolyzed soy protein, with the hydrolyzed soy protein being present in the extrudate at a level of at least about 70% by weight, based upon the total weight of the extrudate taken as 100% by weight. The extrudate also comprises a source of a Group I or II metal. Additionally, the hydrolyzed soy protein comprises a soy protein isolate from a single source.

In another embodiment, the extrudate comprises a hydrolyzed soy protein, with the hydrolyzed soy protein being present in the extrudate at a level of at least about 70% by weight, based upon the total weight of the extrudate taken as 100% by weight. The extrudate also comprises a source of a Group I or II metal, and the extrudate is essentially free of nonhydrolyzed proteins.

In yet a further embodiment, the extrudate comprises a hydrolyzed soy protein, with the hydrolyzed soy protein being present in the extrudate at a level of at least about 70% by weight, based upon the total weight of the extrudate taken as 100% by weight. The extrudate also comprises a source of a Group I or II metal. Additionally, the hydrolyzed soy protein is the sole protein in the extrudate.

### DETAILED DESCRIPTION OF THE PREFERRED EMBODIMENTS

### Mixture Used to Form Products According to Invention

The mixture used to form the inventive product includes a protein source. Suitable proteins can be derived from seeds from the cereal group (e.g., wheat, corn, barley). Other types of protein sources that can be used for this invention include those selected from the group consisting of soybeans, peas, beans, and other legumes, with the preferred source being a soy protein. The protein can be a concentrate or an isolate, but an isolate is preferred. The most preferred isolate is a soy protein isolate.

The preferred protein source will have a protein content of at least about 85% by weight, preferably at least about 90% by weight, and more preferably at least about 93% by weight protein, based upon the total weight of the protein source taken as 100% by weight. The protein utilized is a hydrolyzed protein, and more preferably a hydrolyzed soy protein, and most preferably a hydrolyzed soy protein isolate. Preferred commercial products include Solae Supro 670, Gushen GS 5300A, Gushen GS 5300AW, and Soy Pro 950 (Kerry Ingredients).

The protein source itself is included in the ingredient mixture at levels of at least about 70% by weight, preferably at least about 75% by weight, preferably at least about 85% by weight, and preferably at least about 90% by weight, based upon the total weight of the ingredient mixture taken as 100% by weight. As used herein, % by weight in reference to the “total weight of the ingredient mixture” includes the weight of water mixed into the ingredient mixture during initial wetting in the extruder but before introduction into the extruder, and it does not include the water introduced into the preconditioner during mixing (after the initial ingredient wetting) or the water introduced into the extruder during processing.

It is preferred that the above-described protein source be the sole protein utilized in the ingredient mixture. Additionally, it is preferred that the split of hydrolyzed and nonhydrolyzed proteins utilized in the prior art is avoided with the present invention. Thus, the ingredient mixture is preferably essentially free of nonhydrolyzed proteins. That is, there is preferably less than about 5% by weight, preferably less than about 2% by weight, preferably less than about 1% by weight, and preferably about 0% by weight nonhydrolyzed proteins in the ingredient mixture. It will be appreciated that the invention results in the production of higher-protein products while eliminating the use of two protein sources and removing the issue of reformulation needed by prior art methods due to abrupt changes in the protein-containing ingredients.

The ingredient mixture also includes a disruptive agent for preventing realignment or stratification of the protein strands in the hydrolyzed protein while in the extruder, which would result in the formation of a textured vegetable protein product rather than a crisp rice-like product. Typically, this disruption would take place because the protein wraps itself around the disruptive agent. Preferred disruptive agents include those selected from the group consisting of Group I and II metals. Thus, the ingredient mixture should include a source of a Group I or II metal. Particularly preferred such metals are Ca, Mg, Na, and mixtures thereof, with Ca being particularly preferred. The most referred source is a Group I or II salt, and particularly a calcium salt such as those selected from the group consisting of tribasic calcium phosphate, calcium chloride, dibasic calcium phosphate, calcium carbonate (CaCO₃), and mixtures thereof.

The disruptive agent is preferably present of levels of from about 0.2% to about 4% by weight, preferably from about 0.8% to about 3% by weight, and more preferably from about 1.2% to about 2.5% by weight, based upon the total weight of the ingredient mixture taken as 100% by weight.

The ingredient mixture will also preferably include one or more fillers. The filler is typically from a carbohydrate source and can either be a flour or a more complex carbohydrate starch. The starch could be a modified or pre-gelatinized starch, depending on the desired finished product texture. The preferred fillers are rice in nature and are either a rice flour or rice starch. One such rice starch is produced by the Pencook Company another from Remy Starch. If different textures are desired, different flours and starches derived from wheat, corn, tapioca, and/or potato can also be used. The protein to filler ratio on a dry basis is preferably from about 70:30 to about 99:1, and more preferably from about 78:22 to about 99:1. Stated another way, the filler is preferably included in the ingredient mixture at a level of from about 1.5% to about 20% by weight, preferably from about 1.75% to about 17% by weight, and more preferably from about 8% to about 17% by weight, based upon the total weight of the ingredient mixture taken as 100% by weight.

Water is also included in the ingredient mixture. Although most of the added water either flashes off as steam or is mechanically dried off later in the process, it is very important to deliver enough water to fully hydrate the protein, starch, and calcium. In addition to water being included in the ingredient mixture, it is delivered to the system in several places, as discussed in more detail below. The ingredient mixture will typically include from about 2% to about 10% by weight water, preferably from about 2% to about 8% by weight water, and more preferably from about 2.5% to about 6% by weight water, based upon the total weight of the ingredient mixture taken as 100% by weight.

Finally, a small amount of color, spice, and/or flavor can optionally be added to the blend prior to extrusion, depending on the desired effect. Vitamins, minerals, spices, vegetable powders, fruit powders, and/or other nutrients can also be added if desired, but the overall protein levels would be reduced as the percentages of these ingredients are increased. Thus, it is generally preferred that the ingredient mixture include less than about 5% by weight, preferably less than about 3% by weight, and more preferably from about 0.1% to about 3% by weight of ingredients other than the protein, filler, disruptive agent, and water, based upon the total weight of the ingredient mixture taken as 100% by weight.

In one embodiment, the ingredient mixture consists essentially of (or even consists of) a protein, filler, disruptive agent, water, and the above optional ingredients. In another embodiment, the ingredient mixture consists essentially of (or even consists of) a hydrolyzed protein isolate, filler, disruptive agent, water, and the above optional ingredients. In yet another embodiment, the ingredient mixture consists essentially of (or even consists of) a hydrolyzed soy protein isolate, starch, a calcium salt, water, and the above optional ingredients.

### Method of Forming Products According to the Invention

The protein, filler, disruptive agent, and any other dry ingredients are added to a dry blending device, such as a ribbon blender. Care should be taken that the disruptive agent is evenly distributed throughout the blend prior to conveying the finished blended mixture into a holding silo or other storage means. The well-blended batch is then metered into a preconditioning unit of an extruder from the holding silo.

The formula water mentioned above is metered into the pre-conditioner and is atomized through a number of atomizing nozzles to ensure even distribution throughout the blend. Inside the pre-conditioner, a number of blending paddles on several shafts continue to mix and hydrate the dry blend. Extreme care must be taken not to over-wet the blend as it preferably free falls and meters itself into the throat or inlet of the extruder. It is important that this water is atomized into the unit avoiding large wet pockets and essentially wetting as many particles as possible before delivery to the extruder. Care must be taken not to get the mass too wet as it will not freely feed into the extruder. Preferably, from about 15% to about 40% by weight more water, more preferably from about 20% to about 35% by weight more water, and even more preferably from about 25% to about 30% by weight more water should be added into the pre-conditioner, with the percentage by weight being based upon the total weight of the dry mixture taken as 100% by weight. Those skilled in the art of extrusion would likely question this large amount of water being added prior to the product blend entering the extruder, but it is very important to pre-hydrate sufficiently to guarantee texture.

The preferred type of extruder for manufacturing the inventive product is a twin-screw extruder. The extruder should have a length to diameter ratio of at least about 13:1, and preferably from about 13:1 to about 20:1. The screw profile of the extruder should exhibit significant shear in the design. The screw designs can be very complex and can vary from extruder manufacturer to manufacturer as well as change due to differences in the length to diameter ratio of the extruder. Regardless of these differences, the screw profile preferably exhibits at least three zones where the product undergoes extreme shear.

Once in the extruder the mass is further hydrated by the injection of water directly into the barrel. This amount can vary given the amount of water injected into the pre-conditioner and the type of protein source used, but water is preferably added to the extruder barrel at levels of from about 5% to about 15% by weight, and more preferably from about 7% to about 12% by weight, based upon the total weight of the pre-conditioned mass taken as 100% by weight.

The addition of water at this phase essentially turns the dry material into a viscous dough. The dough is then subjected to significant shear in the extruder, causing the generation of heat that in turn cooks the dough as it moves through the barrel of the extruder. The temperature range of the dough in the extruder barrel should be from about 150° F. to about 240° F., preferably from about 170° F. to about 230° F., and more preferably from about 190° F. and 210° F. Due to the high temperatures generated in the process by shear (frictional energy), cooling of the barrel is typically needed in order to maintain these temperatures.

The dough is then forced under pressure through a die positioned at the extruder outlet. The die is configured to have openings whose sizes regulate the diameters of the final cut pieces. Pressures prior to exiting the extruder should be from about 160 psig to about 250 psig, preferably from about 170 psig to about 230 psig and more preferably from about 190 psig to about 210 psig. Due to these high temperatures and pressures when the extrudate exits the extruder, the water in the system vaporizes, causing expansion of the extrudate. The moisture content of the expanded pieces is usually from about 20% to about 30% by weight, based upon the total weight of the extrudate taken as 100% by weight.

The expanded dough pieces are cut to the desired length and transferred into a drying device to remove most of the remaining water. Several different types of drying devices can be used, but a convectional style oven is most typical. A very hot air impingement-type oven (not unlike a hot air popcorn popper) could also be used to impart a brown color and toasted flavor to the pieces, if desired.

### Final Inventive Product

Upon exiting the oven, the final pieces/extrudate should have a moisture content of from about 2% to about 7% by weight, preferably from about 2% to about 5% by weight, and more preferably from about 2.5% to about 4% by weight, based upon the total weight of the dried extrudate taken as 100% by weight.

The finished extruded product strongly resembles pieces of puffed crisp rice (such as the type commonly used as a breakfast cereal) in shape as well as in texture. The final inventive crisp rice-like pieces will have a protein content of at least about 70% by weight, preferably at least about 75% by weight, more preferably at least about 80% by weight, and even more preferably from about 80% to about 90% by weight protein, based upon the total weight of the final pieces taken as 100% by weight.

In one embodiment, the final pieces consist essentially of (or even consist of) the protein, filler, disruptive agent (and/or the source of the disruptive agent), water, and the above optional ingredients. In another embodiment, the final pieces consist essentially of (or even consist of) a hydrolyzed protein isolate, filler, disruptive agent (and/or the source of the disruptive agent), water, and the above optional ingredients. In yet another embodiment, the final pieces consist essentially of (or even consist of) hydrolyzed soy protein isolate, starch, a calcium salt (and/or the calcium from the calcium salt), water, and the above optional ingredients.

The bulk density of the finished (i.e., after drying) high-protein toasted, crisp rice-like piece should be from about 0.1 g/cm³ to about 0.8 g/cm³, preferably from about 0.15 g/cm³ to about 0.5 g/cm³, and more preferably 0.2 g/cm³ to about 0.35 g/cm³. The finished and dried high-protein crisp rice-like product is then cooled before packaging.

### EXAMPLES

The following examples set forth preferred methods in accordance with the invention. It is to be understood, however, that these examples are provided by way of illustration and nothing therein should be taken as a limitation upon the overall scope of the invention.

### Example 1

In this Example, a finished product with a protein content of 70% by weight was formed. The dry finished product formula for a 70% protein product was as follows:

| INGREDIENT | % BY WEIGHT^{A} |
|---|---|
| Hydrolyzed Soy Protein Isolate^{B} | 78% |
| Long Grain Rice Flour | 16.5% |
| Calcium Carbonate | 0.5% |
| Water | 5% |

^{A}Based upon the total weight of the dry finished product taken as 100% by weight.
^{B}Supro 670 (available from Solae, St. Louis, MO) or GS 5300A (available from Gushen, China).

The dry ingredients are added to a ribbon blender. To ensure that the calcium salt is evenly distributed throughout the blended mixture, the calcium salt is evenly spread across the soy isolate before the addition of the rice flour. The well-blended dry material is moved into a storage hopper and metered into the preconditioning cylinder of the extruder. Water is metered and injected into a double shaft pre-conditioner (Wenger Manufacturing, Sabetha, KS) through at least three atomizing nozzles. This product is run with the addition of 23% water by weight of the product including the injected water. While in the pre-conditioner a thorough wetting of the dry blend takes place. This partially hydrated product is metered into the extruder barrel (Wenger 138 extruder; 515 rpm), and another 13% of water by total weight of the product is added to the mass, and a series of mixing and shearing paddles mix and heat this mass into a viscous dough. The mixed and cooked dough is then passed under a pressure of 210 psig out of an orifice or die. Due to the extreme decrease in pressure on exiting the extruder, moisture in the dough vaporizes, causing the dough to expand. The expanded dough is then cut to the desired size. It is also important to cool the barrel of the extruder to keep the dough temperature from getting too hot due to the large amount of shear inside the extruder.

Once they are expanded and sized, the pieces are sent into an impingement type oven and dried down to 5% in total moisture content. In this Example, the oven temperature is set at 390° F., and the oven residence time is 10 minutes. Due to the high percentage of flour in this particular formula, the crisp rice-like pieces will have a softer bite than those of higher protein, but still sufficient structural integrity to allow them to be mixed with other pieces. A binder would be used as an ingredient in a bar-style product.

### Example 2

A 70% protein soy crisp with added carrot powder can be produced with the following formula:

| INGREDIENT | % BY WEIGHT^{A} |
|---|---|
| Hydrolyzed Soy Protein Isolate^{B} | 78% |
| Long Grain Rice Flour | 13.5% |
| Drum Dried Carrot Powder | 3% |
| Calcium Carbonate | 0.5% |
| Water | 5% |

^{A}Based upon the total weight of the dry finished product taken as 100% by weight.
^{B}Supro 670 or GS 5300A.

The same procedure described with Example 1 was followed, with a few differences. This product is run with the addition of 26% water by weight of the product including the injected water. When the partially hydrated product is metered into the extruder barrel (screw speed 490 rpm), another 11% water is injected into the barrel of the extruder. In this Example, the pressure at the die face was 210 psi. Cooling is even more important in this Example because the sugar in the carrot powder can begin to brown in the product, causing an undesirable color and flavor. Once the pieces are expanded and sized, they are sent into an impingement type oven and dried down to 5% by weight total moisture. In this example the oven temperatures were set to 350° F., and the oven residence time was 10 minutes. As was also the case with Example 1, due to the high percentage of flour in this formula, the crisp rice-like pieces have a softer bite than those of higher protein, but still have sufficient structural integrity to allow them to be mixed with other pieces. A binder can also be used as an ingredient in a bar style product. The finished product also contains a vegetable powder (carrot), which adds both nutritional value and is a food label friendly ingredient.

### Example 3

A high-protein crisp rice piece with added fruit powder can be made with the following formula:

| INGREDIENT | % BY WEIGHT^{A} |
|---|---|
| Hydrolyzed Soy Protein Isolate^{B} | 78% |
| Long Grain Rice Flour | 13.5% |
| Drum-Dried Strawberry Powder | 3% |
| Calcium Carbonate | 0.5% |
| Water | 5% |

^{A}Based upon the total weight of the dry finished product taken as 100% by weight.
^{B}Supro 670 or GS 5300A.

As with the previous Examples, only a small amount of a calcium salt is needed to disrupt the protein fibers. This is not only due to the lower percentage of protein in the formula, but also to the high percentage of rice flour and strawberry powder, which are also disruptive of the protein fibers.

The procedure followed was as described above with respect to Example 1, with the noted exceptions. One difference is that this product is run with the addition of 26% water by weight of the product including the injected water. Another difference is that during metering into the extruder barrel, another 11% water is injected into the barrel. The pressure at the die face in this Example is 210 psig, while the screw speed was 515 rpm.

As was the case with Example 1, it is important to cool the barrel of the extruder to keep the dough temperature form getting too hot due to the large amount of shear inside the extruder. The cooling is even more important in this Example as the sugar in the strawberry powder can begin to brown in the product, causing an undesirable color and flavor. As with Example 1, the pieces were dried down to 5% in total moisture, but with the oven temperatures were set at 390° F., and an oven residence time of 10 minutes. Similar physical properties were achieved in this Example, plus the finished product also contains a fruit powder (strawberry), which adds both color and flavor to the crisp.

### Example 4

In this Example, an 80% protein crisp rice piece can be made with the following formula:

| INGREDIENT | % BY WEIGHT^{A} |
|---|---|
| Hydrolyzed Soy Protein Isolate^{B} | 91.55% |
| Pencook Rice Starch | 4% |
| Calcium Carbonate | 1.85% |
| Water | 2.6% |

^{A}Based upon the total weight of the dry finished product taken as 100% by weight.
^{B}Supro 670 or GS 5300A.

Again, similar procedures were followed as those described in Example 1, with the exceptions noted herein. This product is run through the preconditioner with the addition of26% water by weight of the product including the injected water. Another difference is that another 11% by weight of water is injected into the barrel of the extruder. The pressure at the die face in this Example is 205 psig, and the screw speed is set at 470 rpm.

In this Example, the expanded and sized pieces are dried down to 3% by weight total moisture, as opposed to the 5% by weight of Example 1. For this drying, the oven temperatures are set at 220° F., and the oven residence time is 25 minutes. Because of the high percentage of soy protein in this product (80% by weight), the crisps are much firmer in texture than those in the previous Examples. Although the texture of these pieces is firm, it does not exhibit a glassy nature that creates a gritty mouth feel.

### Example 5

An 88% protein crisp rice piece can be made with the following formula:

| INGREDIENT | % BY WEIGHT^{A} |
|---|---|
| Hydrolyzed Ultra High Soy Protein Isolate^{B} | 94% |
| Pencook Rice Starch | 1.75% |
| Calcium Carbonate | 1.75% |
| Water | 2.5% |

^{A}Based upon the total weight of the dry finished product taken as 100% by weight.
^{B}GS 5300AW (Has at least 94% by weight protein; available from Gushen).

Crisps with protein levels greater than 85% typically need to be made with an ultra high-protein isolate, as was the case with this Example. These isolates must have at least 93%-94% protein content to increase the protein levels in the finished crisp above 85%.

As with previous Examples, the procedure followed in this Example was similar to that followed in Example 1, with the exceptions noted below. In the preconditioner, this product is run with the addition of 26% by weight water of the product including the injected water, and in the extruder, another 11% by weight water is injected into the barrel of the extruder. In this Example, the pressure at the die face is 200 psig, and the screw speed is 485 rpm. The expanded and sized pieces are dried down to 2.5% by weight in total moisture, at an oven temperature of 220° F., and oven residence time of 25 minutes.

Because of the high percentage of soy protein in this product (88%) the crisps are much firmer in texture than those in the previous Examples. Although the texture of these pieces is firm, it does not exhibit a glassy nature that creates a gritty mouth feel.

We claim:

1. A method of forming a high-protein crisp product, said method comprising:
providing a mixture of ingredients, said ingredients comprising a hydrolyzed protein, and a source of a Group I or II metal, and said protein being present in said mixture at a level of at least about 75% by weight, based upon the total weight of the ingredients taken as 100% by weight;
passing said mixture through an extruder so as to form the high-protein crisp product.

2. The method of claim 1, wherein said mixture is essentially free of nonhydrolyzed proteins.

3. The method of claim 1, wherein said hydrolyzed protein is the sole protein in the mixture.

4. The method of claim 1, wherein said hydrolyzed protein comprises soy protein isolate from a single source.

5. The method of claim 1, wherein said source of a Group I or II metal is selected from the group consisting of sources of Ca, Mg, Na, and mixtures thereof.

6. The method of claim 5, wherein said metal is a source of Ca.

7. The method of claim 6, wherein said source is selected from the group consisting of tribasic calcium phosphate, calcium chloride, dibasic calcium phosphate, calcium carbonate, and mixtures thereof.

8. The method of claim 1, wherein said hydrolyzed protein comprises soy protein isolate from a single source, and wherein said Group I or II metal is a source of Ca.

9. The method of claim 1, wherein:
said extruder has an inlet, an outlet, and a barrel in communication with both said inlet and said outlet;
said passing comprises introducing said mixture into said inlet, passing said mixture through said barrel, and introducing water into said barrel; and
said mixture exits said outlet as an extrudate.

10. The method of claim 9, wherein said extrudate expands upon exiting said outlet.

11. The method of claim 1, wherein said high-protein crisp product has a protein content of at least about 70% by weight, based upon the total weight of the high-protein crisp product taken as 100% by weight.

12. The method of claim 1, further comprising subjecting said mixture to preconditioning prior to said passing.

13. The method of claim 1, further comprising drying said high-protein crisp product after said passing.

14. The method of claim 1, wherein said mixture further comprises an ingredient selected from the group consisting of water, fillers, colors, spices, flavoring agents, vitamins, minerals, spices, vegetable powders, fruit powders, nutrients, and mixtures thereof.

15. A high-protein, expanded, crisp extrudate comprising:
a hydrolyzed soy protein, said hydrolyzed soy protein being present in said extrudate at a level of at least about 70% by weight, based upon the total weight of the extrudate taken as 100% by weight; and
a source of a Group I or II metal, wherein said hydrolyzed soy protein comprises a soy protein isolate from a single source.

16. The extrudate of claim 15, wherein said extrudate is essentially free of nonhydrolyzed proteins.

17. The extrudate of claim 15, wherein said hydrolyzed soy protein is the sole protein in the extrudate.

18. The extrudate of claim 15, wherein said source of a Group I or II metal is selected from the group consisting of sources of Ca, Mg, Na, and mixtures thereof.

19. The extrudate of claim 18, wherein said source of a Group I or II metal is a source of Ca.

20. The extrudate of claim 19, wherein said source of Ca is selected from the group consisting of tribasic calcium phosphate, calcium chloride, dibasic calcium phosphate, calcium carbonate, and mixtures thereof.

21. A high-protein, expanded, crisp extrudate comprising:
a hydrolyzed soy protein, said hydrolyzed soy protein being present in said extrudate at a level of at least about 70% by weight, based upon the total weight of the extrudate taken as 100% by weight; and
a source of a Group I or II metal, wherein said extrudate is essentially free of nonhydrolyzed proteins.

22. The extrudate of claim 21, wherein said hydrolyzed soy protein is the sole protein in the extrudate.

23. The extrudate of claim 21, wherein said source of a Group I or II metal is selected from the group consisting of sources of Ca, Mg, Na, and mixtures thereof.

24. The extrudate of claim 23, wherein said source of a Group I or II metal is a source of Ca.

25. The extrudate of claim 24, wherein said source of Ca is selected from the group consisting of tribasic calcium phosphate, calcium chloride, dibasic calcium phosphate, calcium carbonate, and mixtures thereof.

26. A high-protein, expanded, crisp extrudate comprising:
a hydrolyzed soy protein, said hydrolyzed soy protein being present in said extrudate at a level of at least about 70% by weight, based upon the total weight of the extrudate taken as 100% by weight; and
a source of a Group I or II metal, wherein said hydrolyzed soy protein is the sole protein in the extrudate.

27. The extrudate of claim 26, wherein said source of a Group I or II metal is selected from the group consisting of sources of Ca, Mg, Na, and mixtures thereof.

28. The extrudate of claim 26, wherein said source of a Group I or II metal is a source of Ca.

29. The extrudate of claim 28, wherein said source of Ca is selected from the group consisting of tribasic calcium phosphate, calcium chloride, dibasic calcium phosphate, calcium carbonate, and mixtures thereof.
